(19) United States
(12) Patent Application Publication
(10) Pub. No.: US 2015/0134817 A1
(43) Pub. Date: May 14, 2015

(54) CLOUD SERVER AGGREGATOR TO FACILITATE ACCESS AND TRANSMISSION OF DATA STORED ON MULTIPLE CLOUD SERVERS

(71) Applicant: JOSEPH EDWARDS, CAMPBELL, CA (US)

(72) Inventor: JOSEPH EDWARDS, CAMPBELL, CA (US)

(21) Appl. No.: 14/078,397

(22) Filed: Nov. 12, 2013

(51) Int. Cl. H04L 12/911

(52) U.S. Cl. CPC H04L 47/70
USPC 709/225

(57) ABSTRACT

A cloud storage aggregator is provided that permits a user to seamlessly access files stored in multiple cloud servers, where the application permits an exchange of information between users and their computerized device that includes the identity of a plurality of cloud storage systems to which the user subscribes, and any user name and security information associated with each of the plurality of cloud storage systems. The application is configured to automatically exchange files between any one of the plurality of cloud storage systems and the user's computerized device once an initial connection has been made by way of an initialization sequence between the application and the one of the plurality of cloud storage systems, where the user may quickly and easily retrieve data regardless on which of the plurality of cloud storage systems the data is stored. The application also permits the transmission of such files seamlessly.

### BACKGROUND

The embodiments herein relate generally to a system and application for permitting a user seamless access and transmission of files stored on different cloud servers. Recently, users are employing cloud server storage more often, particularly as more cloud server providers emerge providing fairly large storage space for free and greater storage capacity for relatively low fees.

For those who take advantage of the free space, but have accumulated files that exceed the capacity of any one free cloud server provider, the user often subscribes to multiple cloud server providers, each requiring their own security submission and/or authentication by the user for file access. There are also many users who simply subscribe to multiple cloud server providers because they share files with others who have already established a subscription with a particular cloud server provider, each of which may be different. Given the emerging ubiquity of cloud server providers, and the amount of users who therefore store numerous sets of non-redundant files on multiple cloud servers through different cloud server providers, the speed at which access and transmission of documents can be slowed down by the need to individually deal with each cloud server provider separately. The process to move data across two or more cloud providers is not only complex and time consuming, it also consumes battery/energy, local disk space and bandwidth resources. In addition, users are likely to not exchange data or sign up to the one provider another is using only temporarily to obtain the data, and never use that service again.

Indeed, in a survey conducted as recently as late last year, none of the surveyed software available provided for automatic synchronization between a local folder and all supported cloud storage services and between a cloud storage service, a local folder, and the other services. The present invention solves that problem.

### SUMMARY

This software system allows users to exchange data seamlessly across multiple cloud providers. Not only will this system allow the user to exchange data, without local impact, with other users on different cloud platforms, cloud providers themselves will be able to retain users longer by not losing them to sign up for competitors to easily exchange data with other users on that competitor's system.

In one embodiment, a cloud storage aggregator system is provided that permits a user to seamlessly access files stored in multiple cloud storage systems from their computerized device, where the aggregator system comprises a application configured to be accessed by a computerized device. In one example, the application comprises a graphic user interface for the exchange of information between the computerized device and a user of the application, with the information including the identity of a plurality of cloud storage systems to which the user subscribes, and any user name and security information associated with each of the plurality of cloud storage systems. The application is preferably configured to automatically exchange files between any one of the plurality of cloud storage systems and the user's computerized device once an initial connection has been made by way of an initialization sequence between the application and the one of the plurality of cloud storage systems, wherein the graphic user interface comprises at least one screen that permits the user to enter information sufficient to retrieve a file regardless on which of the plurality of cloud storage systems the file is stored without the need for the user to enter account information unique to the cloud storage system on which the file is stored, the application thereby providing a seamless vehicle for the user to access files from any one of the plurality of cloud storage systems.

In another embodiment, a method is provided for sending files stored on one or more cloud storage systems via a client transmittal application. In one example, the client transmittal application comprises one or a number of possible vehicles for electronically communicating information between a sender and recipient from the sender's computerized device to the recipient's computerized device, where the method permits the sender to attach to an electronic communication a file stored on one of a plurality of cloud storage systems using the client transmittal application such that the recipient may link to the file and save the file to any of the recipient's cloud storage systems, regardless of whether the file source was a different cloud storage system. In one version, the method comprises accessing a client transmittal application stored on a user's computerized device, and interfacing with the application by way of software code executable on the user's computerized device, where the executable code preferably causes a dialog box to appear on a graphic user interface screen viewable on the user's computerized device when the user desires to send an electronic communication to a recipient using the client transmittal application, and where the dialog box comprises a plurality of tabs each linked to one of a plurality of cloud storage systems to which the user has established an account and has uploaded files for storage thereon. In such a scenario, when a user desires to send a file as an attachment to an electronic communication, the dialog box permits the user to click on the tab associated with the cloud storage system containing the desired file and to attachment the file to the electronic communication for transmission to the recipient. Other examples and embodiments are presented below.

### BRIEF DESCRIPTION OF THE FIGURES

The detailed description of some embodiments of the invention will be made below with reference to the accompanying figures, wherein like numerals represent corresponding parts of the figures.

FIG. 1 shows a schematic view of one embodiment of the present invention.

### DETAILED DESCRIPTION OF CERTAIN EMBODIMENTS

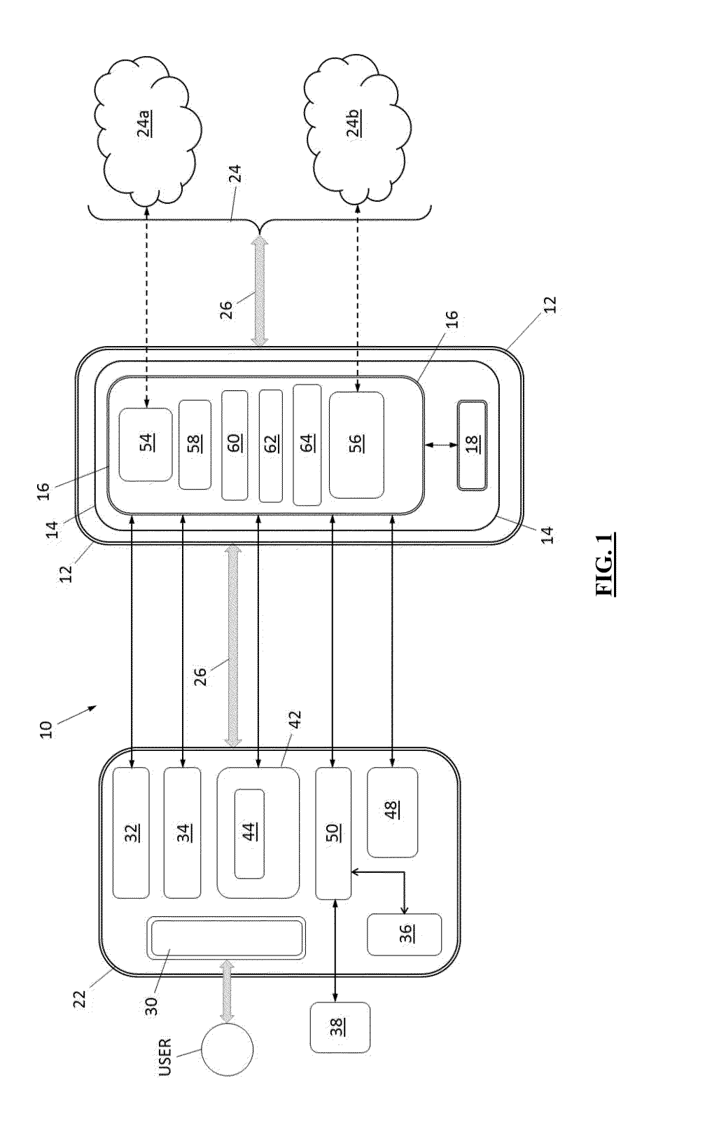

By way of example, and referring to FIG. 1, one embodiment of the present system 10 comprises an comprises aggregated file system storage provider 12 comprising a server computer 14. In some systems, the server computer 14 comprises a file storage aggregation API 16 and a backend processing system 18. With embodiments of the invention herein, such as system 10 of FIG. 1, they are configured to interface with a user's computerized device 22, whether it be a desktop, laptop, notebook, tablet, smart phone or the like. In some cases, embodiments of the invention may comprises software installed onto the user's computerized device 22 (e.g., desktop or laptop), or it may comprise an application downloadable to the user's computerized device 22 (e.g., tablet or smart phone). It is also contemplated that embodiments of the present invention be entirely web-based applications, if so desired. In any case, embodiments of the invention are preferably configured to interface with any and all such computerized devices.

Importantly, embodiments of the system, such as system 10, are also configured to interface with a plurality of cloud file storage providers 24, which may be as little as two or as many as the user desires to associate with the system 10. In FIG. 1, two cloud file storage providers 24a, 24b are illustrated by way of example. There are numerous such cloud file storage providers in existence today, and need not be mentioned by name here as most are effective at storing client data for remote access via one of numerous user devices. The interface between the aggregated file system storage provider 12 and both the user's device 22 and the cloud file storage providers 24 are preferably established via a private or public network or through the Internet.

For purposes of clarity of reference, it is presumed that user devices 22 would include a graphic user interface 32 to permit the user to input information and control the functionality permitted by the user's device and the inventive embodiments herein. Such user devices 22 may also include a standard web browser 32, a driver/application for cloud access 34, local storage (such as a hard drive or solid state memory) 36 and possibly an external hard drive or solid state memory 38, if so desired. To employ one of the benefits of embodiments of the present invention, user devices 22 preferably also include an email client 42, such as Microsoft Outlook, an email client plug-in 44, and possibly one or more social network applications 48, each of which permit a user to transmit digital data electronically through a network or Internet. Some of the above features may not be on every user device, as some as optional features not necessary for use of the device or for interface with embodiments of the present invention.

In embodiment 10 of the invention, the system comprises an aggregation adapter agent for client storage 50 that may be installed and/or downloaded onto the user's device 22 when not using a web-based version of the invention. Such an agent for client storage 40 permits effective interface with an embodiment of the server computer 14 of the aggregated file system storage provider 12. In that regard, the server computer 14 may further comprise an Aggregation Adapter 54, 56, for each of File Storage Providers 24a, 24b, respectively. The server computer 14 preferably further comprises a URL shortening API 58, digital rights management system 60, a social payment system 62, and an aggregation adapter for client storage 64.

In use, replying upon one of several possible routes of access to a network or the internet, including the web browser 32 the driver/application for cloud access 34, or an email client 42 with email client plug-in 44 alone or in any combination to access files from any number or combination of cloud file storage providers 24. With embodiments of the present invention employed, from the user's perspective, regardless of desktop application or combination of applications, the files and directories viewed and manipulated all appear to come from one single file storage provider, when in fact the files and directories are aggregated.

The URL shortening API 58 allows the user and/or the system to take an http URL input by the user and shorten it, as well as unify the domain name. This allows, for example, the system to extend the perception to the users and any users to whom links of the files are shared by the original user that all the files are on one provider when in fact they are really aggregated amongst several, or an unlimited combination thereof. In one example of URL shortening in the context of aggregated cloud files, as permitted by embodiments of the invention, a URL such as http://filestorageproviderA.com/web/production/producst/link=abc can be converted to http://aggregatedfileservice.com/link=123.

It is contemplated that, with embodiments of the present invention, users may perform one or more of the following actions on cloud-stored files using any one or combination of above vehicles for accessing those cloud-based files, including moving files and/or folders between providers, deleting Files and/or folders, downloading files and/or folders to local computerized, and/or emailing a link to the files and/or folders to one or more recipients. The inventive embodiments would also permit a user to request that a file, directory, or directory of files be transformed via a backend processing system 18, which allows the user and/or the aggregated file system storage provider system to request asynchronous processing of files on any combination of cloud storage providers 24. The user may directly or indirectly initiate the processing by using any one or combination of above vehicles for accessing those cloud-based files. Once the processing is complete, the aggregated file system storage provider 12 may notify the user via, for example, email, text message, MMS message, instant message, and/or digital transmission available.

With regard to backend processing system 18, the aggregated file system storage provider 12 and/or user initiated operations will be serviced by the backend processing system 18. Those operations may include, but are not limited to, any combination of the following: a. converting one file into multiple files of a similar or different format, b. converting multiple files in into a single file of a similar or different format, c. performing operations on files that may include creation of one or multiple further tasks to be performed on the source, destination, or any other file regardless of location, d. converting the file to and from a video or compression format, e. copying, moving, deleting, archiving, backing up or in any other way changing a single file, a directory of files, every file in the directory, or any combination of the above using simple and/or compound filters to assess which files have received which operations performed thereon. All of these operations may be user initiated, or system initiated, or configured by the user to operate at a certain time and/or set of conditions.

The driver/application for cloud access 34 allows the user to view the aggregated files and folders as presented by the aggregated file system storage provider 12. The files and/or folders appear to be local files and folders. The user may use a third party or operating system specific application for file and folder administration and access. As the files appear to be local, a conventional file system application such as Windows Explorer® or Finder™ for Mac, for example, remain unaware of the remote and/or aggregated nature of the files and/or folders.

The aggregation adapter agent 50 is preferably configured to interface and monitor the local and external memory 38, 42 of the user's computerized device 22 for any kind of data or structure change operation. The aggregation adapter agent 50 communicates with the file storage aggregation API 16 so that the aggregated file system storage provider 12 preferably maintains a cached copy of the files and directories of any combination of the local and external memories 38, 42. The effect is that the user is able to browse files on any computer that has the aggregation adapter agent 50 installed with appropriately configured combinations of local and/or external memory drives.

The aggregation adapter for client storage 64 enables the file storage aggregation API 16 to add information on local online and/or offline files to the view of aggregated files presented to the user. All previous operations possible, explained above, are enabled with both local and offline files. With offline files, the user may just be given information on which external device and under which folder the file and/or folders exist.

The social network application 48 of the user's computerized device 22 is typically developed to run inside and/or in accordance with the APIs of a given social network 48. A user may user the social network to access the functionality of the aggregated file system storage provider 12.

In addition to the aggregated file view that embodiments of the present invention provide to a user, many embodiments also comprise features that permit a user to share access to select areas of cloud-stored files and folders as viewed via the aggregated file system storage provider 12. The user may control viewing, editing, deleting and modification permissions of any and all files hosted via the aggregate capabilities of the aggregated file system storage provider 12. To the user, and any users who have been granted access by the user or other user delegated by the user to have such access and permissions, the aggregated file system storage provider 12 continues to provide an aggregated view of the files in combination with a URL shortening API 58.

Thus, users may easily share, create and modify files amongst each other, regardless of the aggregation adapter for file storage provider 54, 56 employed, or on which local or external memory drive the filed is stored. The aggregated file system storage provider 12 system may also interact in an automatic or quasi-automatic format to notify the social network 48 user and approved social network users of the effects of files and/or folders anywhere in the aggregation adapter for file storage provider 12 as any file, folder or process directly or indirectly relates to transitions to or from any given known or unknown state.

The social payment system 62 feature of some embodiments of the present invention permit users to engage in financial transactions based upon movement and/or modification of digital goods. This effectively allows owners of content to sell and receive payment for transfer or modification of digital goods that are hosted as aggregated content via the aggregated file system storage provider 12. This content maybe accessible via any application discussed above. Backend processing may also work with a digital rights management system 60 and a social payment system 62, to allow the user to purchase and/or sell digital content that is hosted by the aggregated file system storage provider 12. The digital rights management system 60 preferably is configured to allow for personalization of content either via a third party digital rights management encryption scheme and/or an digital watermarking system that brands and embeds the purchasing user's identity into the content. The backend processing system 18 coordinates with the digital rights management system 60 and social payment system 62 to allow users to purchase and sell content that may or may not have rights protection.

Once the user installs and/or uploads embodiments of the present invention, or accesses the functionality through a web-based program, the users are preferably encouraged to configure the system to allow access to any combination of supported file storage providers 24a, 24b. After initial setup, the user may use any combination of applications to access their cloud-stored digital content, from one single aggregated file system storage provider 12, instead of having to access each individual file storage providers 24a, 24b separately.

The file storage aggregation API 16 is configured to communicate with any number or combination of specified file storage providers 24a, 24b. While each file storage providers 24 typically has distinctly different APIs, the file storage aggregation API 16 presents one unified API, which transmutes the content from multiple file storage providers 24 to appear to come from only one, with one simple API. All of the above described applications are written to communicate with the file storage aggregation API 16, which thereby allows the applications to have aggregated access to the user's content regardless of which file storage providers 24 have stored a given file or folder.

Any system that exposes an API similar to the file storage providers 24 could be implemented as a aggregation adapter for an embodiment of a file storage provider 24 to provide a file serving service. For example, instead of files, the content of an XML file could be used as aggregation adapter for file storage providers 24.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A cloud storage aggregator system configured to permit a user to seamlessly access files stored in multiple cloud storage systems from their computerized device, the aggregator system comprising a application configured to be accessed by a computerized device, the application comprising a graphic user interface for the exchange of information between the computerized device and a user of the application, the information including the identity of a plurality of cloud storage systems to which the user subscribes, and any user name and security information associated with each of the plurality of cloud storage systems, the application configured to automatically exchange files between any one of the plurality of cloud storage systems and the user's computerized device once an initial connection has been made by way of an initialization sequence between the application and the one of the plurality of cloud storage systems, wherein the graphic user interface comprises at least one screen that permits the user to enter information sufficient to retrieve a file regardless on which of the plurality of cloud storage systems the file is stored without the need for the user to enter account information unique to the cloud storage system on which the file is stored, the application thereby providing a seamless vehicle for the user to access files from any one of the plurality of cloud storage systems.

2. The aggregator system of claim 1, wherein the computerized device may be a desktop computer, a laptop computer, a tablet computer, or a smart phone.

3. The aggregator system of claim 1, further comprising a graphic user interface screen presenting the user with security preference settings that permit the user to set how many times file retrieval may occur without authentication with the cloud storage system on which the file is stored.

4. The aggregator system of claim 1, wherein the application comprises software downloadable to the computerized device.

5. The aggregator system of claim 1, wherein the application comprises a web-based application remotely stored on a server to which the user may obtain access by way of the user's computerized device through the Internet or a wireless communications service.

6. A method of aggregating a plurality of cloud storage systems seamlessly to a user who has established accounts for the storage of files in each of the plurality of cloud storage systems, the method permitting a user to access files from any one of the plurality of cloud storage systems without the need of entering account information associated with the plurality of cloud storage systems for each file the user desires to retrieve, the method comprising:
establishing through use of a computerized device an account with a plurality of cloud storage systems, wherein the account includes user account information and authentication information;
initializing by way of a software application communication between the computerized device and each of the plurality of cloud storage systems, the initializing creating a stored handshake protocol between the computerized device and the plurality of cloud storage systems for later access to files stored on the plurality of cloud storage systems without need of further manual authentication by the user; and
displaying on the computerized device a graphic user interface screen configured to permit a user to retrieve one or more files from any one of the plurality of cloud storage systems without having to engage in authentication with the cloud storage systems on which the one or more files are stored so that the retrieval of files is seamless to the user regardless on which of the plurality of cloud storage systems the file is stored.

7. The method of claim 6, wherein the computerized device may be a desktop computer, a laptop computer, a tablet computer, or a smart phone.

8. The method of claim 6, further comprising providing a security preference setting though a graphic user interface screen that permits the user to set how many times file retrieval may occur without manual authentication with the cloud storage system on which the file is stored.

9. The method of claim 6, wherein the software application comprises a web-based application remotely stored on a server to which the user may obtain access by way of the user's computerized device through the Internet or a wireless communications service.

10. The method of claim 6, wherein the software application comprises software downloadable to the computerized device.

11. A method of sending files stored on one or more cloud storage systems via a client transmittal application, the client transmittal application comprising one or a number of possible vehicles for electronically communicating information between a sender and recipient from the sender's computerized device to the recipient's computerized device, the method permitting the sender to attach a file stored on one of a plurality of cloud storage systems to an electronic communication using the client transmittal application such that the recipient may link to the file and save the file to any of the recipient's cloud storage systems, regardless of whether the file source was a different cloud storage system, the method comprising:
accessing a client transmittal application stored on a user's computerized device; and
interfacing with the application by way of software code executable on the user's computerized device, the executable code causing a dialog box to appear on a graphic user interface screen viewable on the user's computerized device when the user desires to send an electronic communication to a recipient using the client transmittal application, the dialog box comprising a plurality of tabs each linked to one of a plurality of cloud storage systems to which the user has established an account and has uploaded files for storage thereon;
whereby when a user desire to send a file as an attachment to an electronic communication, the dialog box permits the user to click on the tab associated with the cloud storage system containing the desired file and to attachment the file to the electronic communication for transmission to the recipient.

12. The method of claim 11, wherein attachment of the file to the electronic communication comprises merely a link to the file, whereby the link may be accessed by the recipient of the electronic communication for purposes of retrieving the actual file and storing the actual file on the recipient's cloud storage system.

13. The method of claim 11, further comprising providing a security preference setting though a graphic user interface screen that permits the user to set how many times file attachment may occur without manual authentication with the cloud storage system on which the file is stored.
